(19) United States
(12) Patent Application Publication
(10) Pub. No.: US 2008/0186254 A1
(43) Pub. Date: Aug. 7, 2008

(54) PORTABLE HEADS-UP DISPLAY SYSTEM FOR CELLULAR TELEPHONES

(76) Inventor: Craig L. Simmons, Chatsworth, CA (US)

Correspondence Address: LATHROP & GAGE LC, 2345 GRAND AVENUE, SUITE 2800, KANSAS CITY, MO, 64108, US

(21) Appl. No.: 11/670,200

(22) Filed: Feb. 1, 2007

(51) Int. Cl. G09G 5/00

(52) U.S. Cl. 345/7

(57) ABSTRACT

A portable heads-up display system for a cellular telephone. The display system includes a transparent, flexible display panel removably affixable to a windshield of a vehicle, a keypad for entering cellular telephone numbers to be dialed, and a keypad box, coupled between the cellular telephone and the display. The display is affixed via temporary means to a part of the vehicle within reach of a hand of a driver of the vehicle. The keypad box sends information from the cellular telephone and the keypad to the display panel.

### BACKGROUND

It has become common to use cellular telephones in automobiles, while an automobile is being driven. Regardless of the type of cellular telephone being used, a driver generally views some type of display to dial a telephone number, or to see information concerning an incoming call, such as the caller ID. Most presently known in-vehicle display devices, including LCD panels and other types of monitors, require drivers to take their eyes off the road, which presents a safety hazard. Other in-vehicle display devices that appear as ‘heads-up’ displays require that the devices and support hardware be permanently installed in the vehicle. What is needed is a portable heads-up display system for a cellular telephone that can easily be installed in any particular vehicle, while being removable and transportable from one vehicle to another.

### SOLUTION TO THE PROBLEM

A system and method are disclosed for displaying cellular telephone-related information via a portable heads-up display in automobiles and other transportation vehicles.

The present system includes a transparent, flexible display panel removably affixable to a windshield of a vehicle, a keypad for entering cell phone numbers to be dialed, and a keypad box, coupled between the cellular telephone and the display, and affixed via temporary means to a part of the vehicle within reach of a hand of the vehicle's driver. The keypad box sends information from the cellular telephone and the keypad to the display panel.

### BRIEF DESCRIPTION OF THE DRAWINGS

FIG. 1A is a diagram showing a high-level view of one exemplary embodiment of the present system;

FIG. 1B is an exemplary diagram showing a high-level view of one alternative embodiment of the present system;

FIG. 2A is a diagram of an exemplary embodiment showing information displayable on a heads-up display in accordance with the present system;

FIG. 2B is a diagram of an exemplary embodiment showing a heads-up display in accordance with the present system;

FIG. 2C is a diagram of an exemplary alternative embodiment showing details of a wireless heads-up display assembly in accordance with the present system;

FIG. 3A is a diagram of an exemplary embodiment showing user input control mechanisms on the top side of a keypad/display control box;

FIG. 3B is a diagram of an exemplary embodiment showing details of a keypad/display control box using electrically-conducting media to provide communication between the control box and heads-up display;

FIG. 3C is a diagram of an exemplary embodiment showing details of a keypad/display control box using a wireless protocol to provide communication between the control box and heads-up display;

FIG. 4A is a diagram showing an exemplary heads-up display in one embodiment of the present system;

FIG. 4B is a diagram showing exemplary construction of an alternative embodiment of the present system in which an LCD display is employed; and

FIG. 4C is a diagram showing details of an exemplary construction of the display of FIG. 4B.

### DETAILED DESCRIPTION

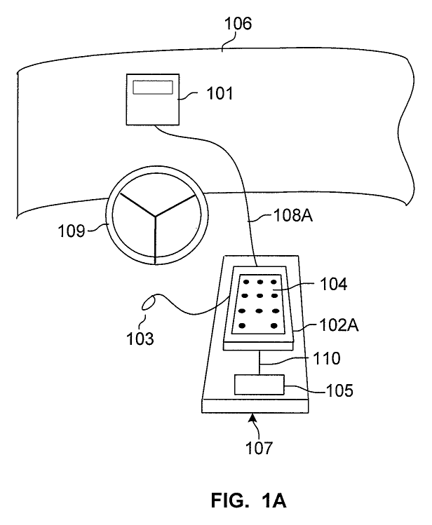

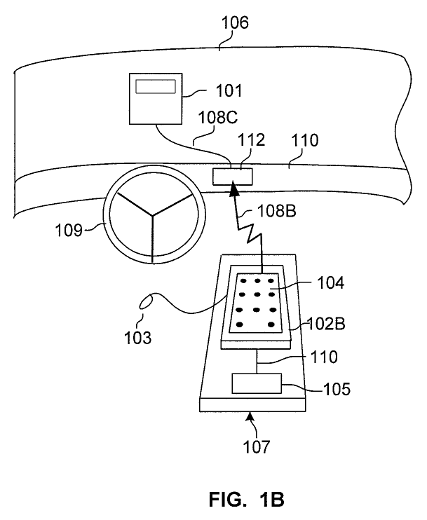

The present method employs existing technology to provide a portable heads-up display for cellular telephones used in automobiles and in other means of transportation. FIG. 1A is a diagram showing a high-level view of one exemplary embodiment of the present system. As shown in FIG. 1A, a heads-up display panel 101 (described in detail below) is removably affixed to a windshield 106 of an automobile or other vehicle. The heads-up display 101 is typically placed on the windshield at a driver's eye-level, which, in the case of an automobile, is directly above the steering wheel 109.

In the embodiment shown in FIG. 1A, heads-up display 101 is connected to a touch pad or keypad (hereinafter “keypad”) 104 (also described in detail below) via wiring 108A and touch-pad box 102A, which may be affixed, typically via temporary means such as Velcro®, double-sided clear tape, or temporary adhesive, to an armrest or console 107 or other part of the vehicle within reach of a driver's hand. Touch-pad box 102A is connected to a cellular telephone 105 via wiring 110, and also to an earphone or other audio transducer 103. Alternatively, display 101 may be temporarily affixed to the windshield using a transparent plastic plate (not shown), glued to the windshield 106, having a slot in which to place the display. As a further alternative, transparent (e.g., silicone compound) suction cups may be attached to display unit 101 to affix the display temporarily to the windshield.

FIG. 1B is an exemplary diagram showing a high-level view of one alternative embodiment of the present system, in which touch-pad box 102B is wirelessly coupled (per arrow 108B) with heads-up display 101 via display control box 112. In the present embodiment, touch-pad box 102B may be affixed, via temporary means, to an armrest or console 107 or other part of the vehicle in reasonable proximity to heads-up display 101. Display control box 112 is connected to heads-up display 101 via wiring 108C. In the embodiments shown in FIGS. 1A and 1B, audio transducer 103 may be either an earphone or a loudspeaker.

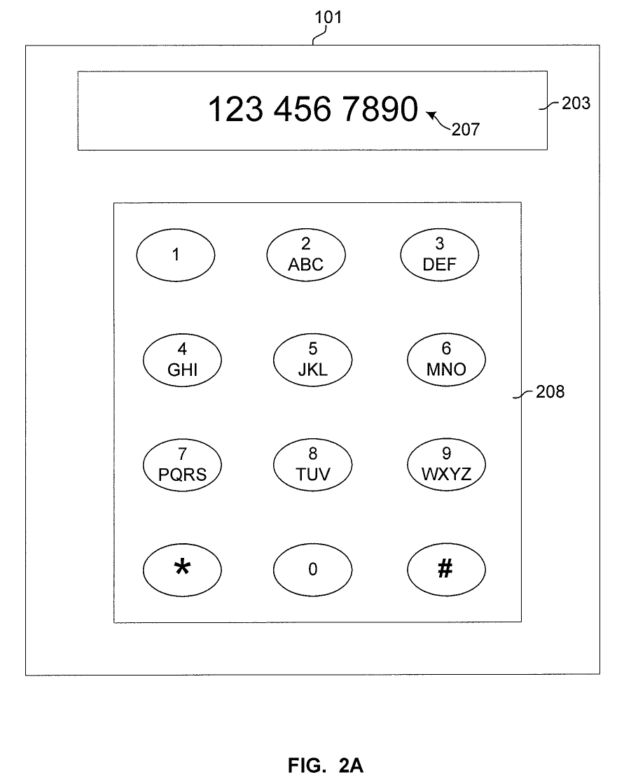

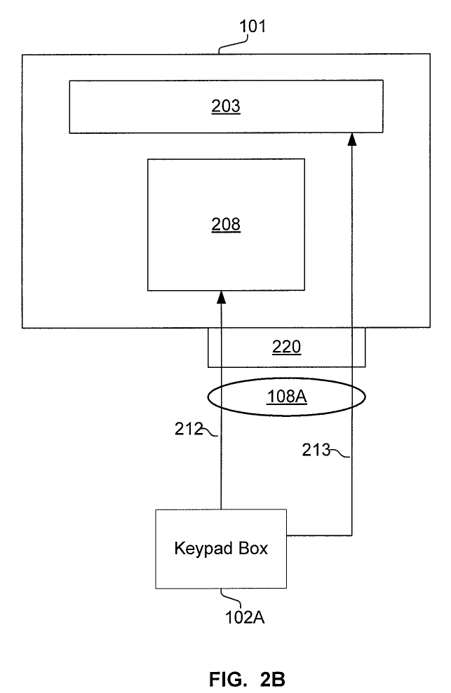

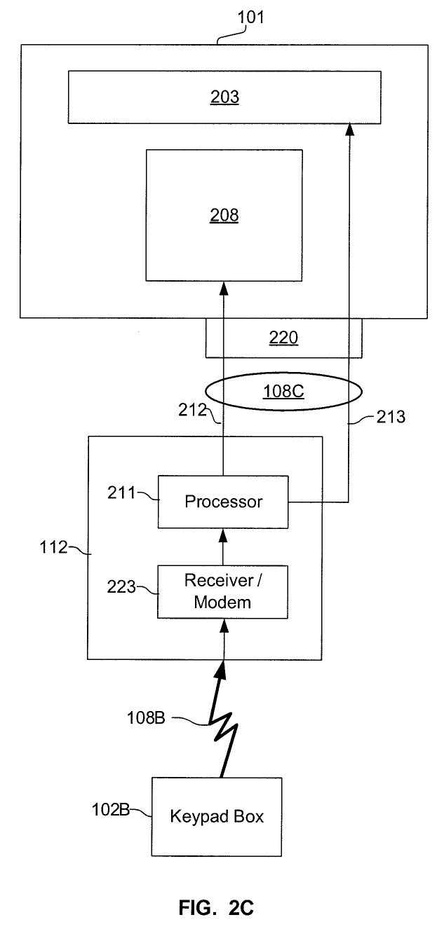

FIG. 2A is a diagram of an exemplary embodiment showing information displayable on a heads-up display 101 in accordance with the present system. As shown in FIG. 2A, heads-up display 101 includes sub-displays 203 and 208. Sub-display 203 typically displays either a caller ID (for an incoming call) or a phone number dialed on keypad 104. Sub-display 208 typically displays a representation of a telephone keypad, in which a particular digit, corresponding to a button pressed by a user on keypad 104, is displayed. It should be noted that sub-display 203 may be used to display information other than a caller ID or a user-dialed phone number 207.

FIG. 2B is a diagram of an exemplary embodiment showing a heads-up display 101 in accordance with the present system. As shown in FIG. 2B, heads-up display 101 is connected to touch-pad box 102A via wiring 108A, which comprises electrically-conducting media (e.g., wires or cables) 212 and 213. Wire/cable 212 is coupled to sub-display 208 and wire/cable 213 is coupled to sub-display 203 via connector port 220. Sub-displays 203 and 208 are driven by signals sent from keypad/display control box 104, which is described in detail below.

FIG. 2C is a diagram of an exemplary alternative embodiment showing details of a wireless heads-up display assembly 101/112 in accordance with the present system. As shown in FIG. 2C, sub-displays 203 and 208 within heads-up display 101 are connected to, and driven by, processor 211 in display control box 112, via wiring 108C and connector port 220. Processor 211 receives and decodes signals received by receiver/modem 223, which itself receives control signals from touchpad box 102B via a wireless protocol 108B, such as that employed by a television RF remote control device or garage door opener. More specific examples of wireless protocols that may be employed by the present system include the IEEE 802.11 family of standards known collectively as ‘Wi-Fi’, and Bluetooth (also known as the IEEE 802.15 standard) protocols.

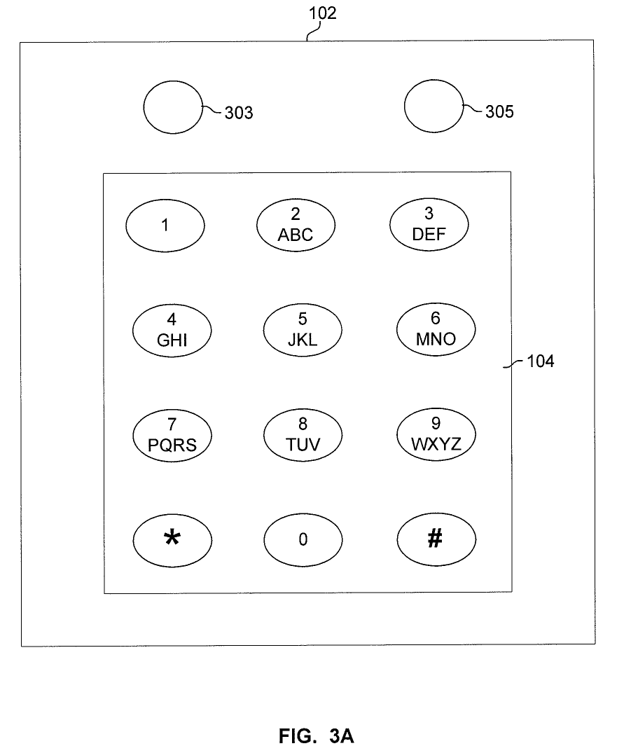

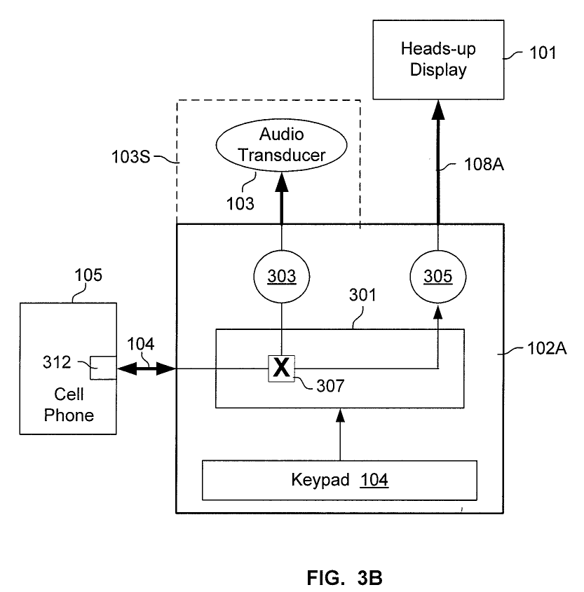

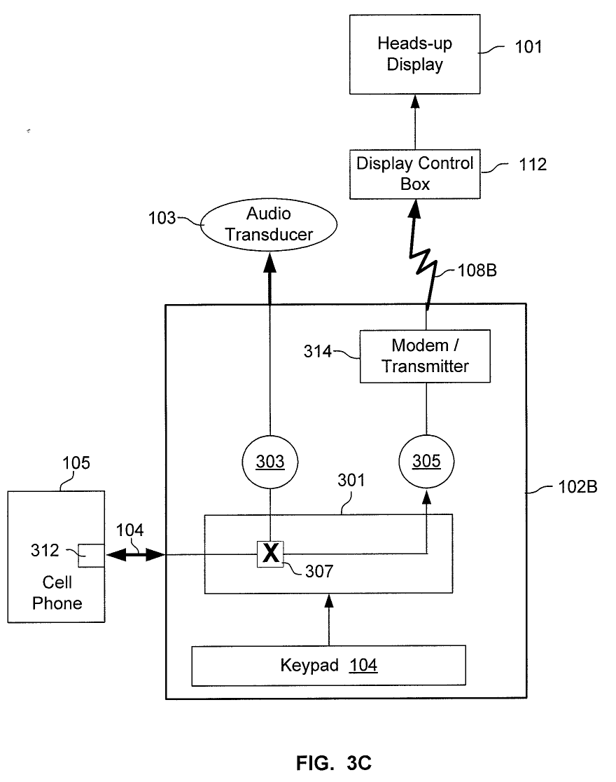

FIG. 3A is a diagram of an exemplary embodiment showing user input control mechanisms on the top side of touchpad box 102. These user input control mechanisms include telephone keypad 104, and signal attenuators 303 and 305, which may be variable resistors or other signal amplitude control devices. Attenuator 303 is employed to control the volume of audio transducer 103, and attenuator 305 is used to control the brightness of heads-up display 101. Telephone keypad 104 may be a touch pad or other type of keypad suitable for providing user input of telephone numbers and other associated data to touchpad box 102A or 102B. The user input control mechanisms shown on touchpad box 102 in FIG. 3A are identical for each of the embodiments 102A and 102B, as depicted in FIGS. 3B and 3C, respectively.

FIG. 3B is a diagram of an exemplary embodiment showing details of a touchpad box 102A using electrically-conducting media 108A to provide communication between the control box and heads-up display 101. As shown in FIG. 3B, processor 301 in touchpad box 102A is connected to send and receive signals from an I/O port 312 on cellular telephone 105 via a cable or connector 104. Processor 301 also receives input from keypad 104. Processor 301 includes a software or firmware-controlled switch 307 for decoupling audio data from telephone number data received from cellular telephone 105, and directing the decoupled data to the appropriate signal attenuator 303/305. In an embodiment wherein a speaker 103S is used instead of an earphone, it is preferably housed within touchpad box 102A, as indicated by dashed box 103S.

FIG. 3C is a diagram of an exemplary embodiment showing details of a touchpad box 102B using a wireless protocol to provide communication between the touchpad box 102B and heads-up display 101. The embodiment shown in FIG. 3C is similar to that of FIG. 3B, with the system of FIG. 3C having, in addition, modem/transmitter 314. Modem/transmitter 314 encodes signals received from processor 301, and sends the encoded signals to heads-up display 101 via a wireless protocol 108B, such as one of the protocols indicated above in the description of FIG. 2C.

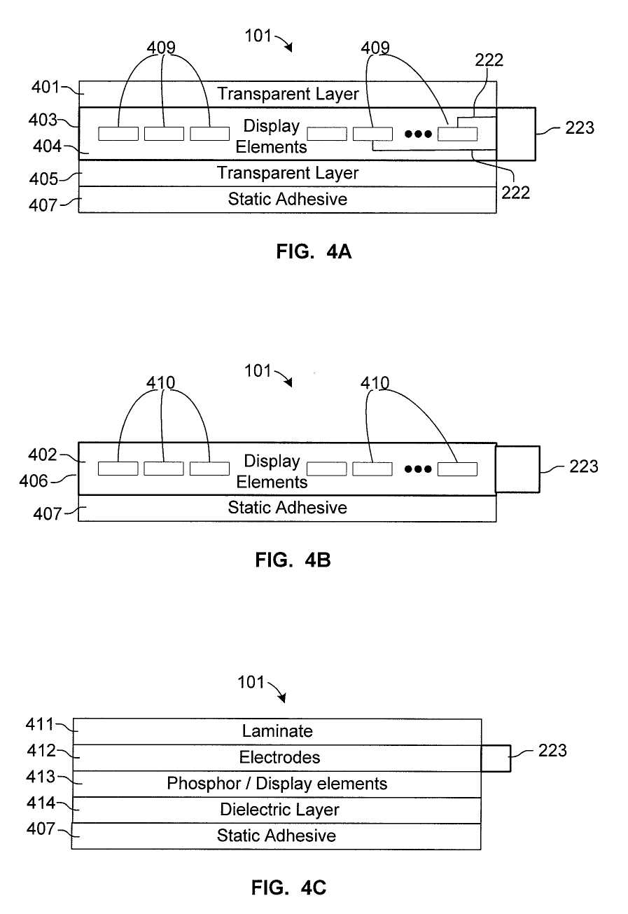

FIG. 4A is a diagram showing an exemplary heads-up display 101 in one embodiment of the present system. As shown in FIG. 4A, electroluminescent filaments (hereinafter “display elements”) 409 are placed between two transparent sheets 401/405 of plastic or other transparent, flexible material, such as SentryGlas film laminate, manufactured by 3M® Company. The term “transparent”, as used herein, is intended to include translucent material as well as essentially transparent material. Electrical connections for driving each of the display elements 409 are made via trace wiring 222 connected to port 223 on an edge of the display 101.

In the present embodiment, the electroluminescent display, comprising layers 401/403/405 is sandwiched between the two layers of the transparent material using an adhesive 404 comprising a transparent filler substance, such as 3M® “ultra-clean laminating adhesive 501FL”.

Heads-up display 101 is removably affixed to a windshield 106 of an automobile or other vehicle using a clear, static adhesive layer 407, such as Invent It!™ brand clear decal material, which is applied to one side of the electroluminescent assembly. The decal material adheres to a smooth surface, e.g., a glass or Plexiglas® windshield 106, by means of static electricity.

FIG. 4B is a diagram showing exemplary construction of an alternative embodiment of the present system in which LCD (liquid crystal display) elements are employed as the electroluminescent light source. As shown in FIG. 4B, LCD elements 410 are embedded in a transparent material 402 to form display 406. As in the method described with respect to FIG. 4A, electrical connections for driving each of the display elements 409 are made via trace wiring (not shown) connected to port 223 on an edge of the display 101. Display 101 is removably affixed to a windshield 106 of an automobile or other vehicle using a clear, static adhesive layer 407.

FIG. 4C is a diagram showing details of an exemplary construction of another alternative transparent electroluminescent display 101 using thick-film technology which is known in the art. As shown in FIG. 4C, display 101 includes a transparent substrate 411, transparent electrodes 412 deposited on the substrate, a phosphor layer 413, deposited on the transparent electrodes 412, which is illuminated when placed in an electric field. A dielectric layer 414 is then deposited on the phosphor layer 413. Phosphor layer 413 is deposited or etched in a pattern suitable for displaying alphanumeric characters. Electrical connections for driving each of the display elements in the phosphor are made via trace wiring (not shown) connected between electrodes 412 and port 223 on an edge of the display 101. A clear, static adhesive layer 407 is then applied to dielectric layer 414, so that the display may be removably affixed to a windshield 106 of an automobile or other vehicle.

Certain changes may be made in the above methods and systems without departing from the scope of that which is described herein. It is to be noted that all matter contained in the above description or shown in the accompanying drawings is to be interpreted as illustrative and not in a limiting sense. For example, the system shown in the accompanying Figures may include different components than those shown in the drawings. The elements shown in the present drawings may be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall there between.

What is claimed is:

1. A portable heads-up display system for a cellular telephone comprising:
a transparent, flexible display panel removably affixable to a windshield of a vehicle;
a keypad for entering cellular telephone numbers to be dialed; and
a keypad box, coupled between the cellular telephone and the display, and affixed via temporary means to a part of the vehicle within reach of a hand of a driver of the vehicle;
wherein the keypad box sends information from the cellular telephone and the keypad to the display panel.

2. The portable heads-up display of claim 1, wherein the display panel includes at least one sub-display for displaying the information from the cellular telephone and the keypad.

3. The portable heads-up display of claim 1, wherein the information includes a phone number dialed on a the keypad.

4. The portable heads-up display of claim 1, wherein the information includes a phone number dialed on a the keypad and a caller ID for an incoming call.

5. The portable heads-up display of claim 1, wherein the display panel is removably affixed to the windshield via static electricity.

6. The portable heads-up display of claim 1, wherein the keypad box is also connected to an audio transducer for annunciating audio information received by the cellular telephone.

7. The portable heads-up display of claim 1, further including:
a first processor, located in the keypad box and coupled to the cellular phone and to the keypad to receive information from the phone and the keypad;
a modem/transmitter, located in the keypad box, for encoding the information received from the first processor and sending the signals thus encoded to the display panel via a wireless protocol;
a receiver/modem, located separately from the keypad box in a display control box, for receiving the information from the modem/transmitter; and
a second processor for receiving and decoding signals from the receiver/modem, and sending the signals thus decoded to the display panel;
wherein the information includes a phone number dialed on a the keypad, from the cellular telephone and the keypad to the display panel.

8. The portable heads-up display of claim 1, wherein the information sent from the cellular telephone to the display panel includes a caller ID for an incoming call.

9. The portable heads-up display of claim 1, wherein the information sent from the cellular telephone to the display panel includes a phone number dialed on a the keypad.

10. A portable heads-up display system for a cellular telephone comprising:
a transparent, flexible display panel removably affixable to a windshield of a vehicle;
a keypad for entering cellular telephone numbers to be dialed;
a keypad box, coupled between the cellular telephone and the display, and affixed via temporary means to a part of the vehicle within reach of a hand of a driver of the vehicle;
a first processor, located in the keypad box and coupled to the cellular phone and to the keypad to receive information from the phone and the keypad;
a modem/transmitter, located in the keypad box, for encoding the information received from the first processor and sending the signals thus encoded to the display panel via a wireless protocol;
a receiver/modem, located separately from the keypad box in a display control box, for receiving the information from the modem/transmitter; and
a second processor for receiving and decoding signals from the receiver/modem, and sending the signals thus decoded to the display panel;
wherein said information includes a phone number dialed on a the keypad, from the cellular telephone and the keypad to the display panel.

11. The portable heads-up display of claim 10, wherein the display panel includes at least one sub-display for displaying the information from the cellular telephone and the keypad.

12. The portable heads-up display of claim 10, wherein the information includes a phone number dialed on a the keypad.

13. The portable heads-up display of claim 10, wherein the information includes a phone number dialed on a the keypad and a caller ID for an incoming call.

14. The portable heads-up display of claim 10, wherein the display panel is removably affixed to the windshield via static electricity.

15. The portable heads-up display of claim 10, wherein the display is temporarily affixed to the windshield using a transparent plastic plate, glued to the windshield, having a slot in which to place the display.

16. The portable heads-up display of claim 10, wherein transparent suction cups are attached to the display to affix the display temporarily to the windshield

17. The portable heads-up display of claim 10, wherein the keypad box is also connected to an audio transducer for annunciating audio information received by the cellular telephone.

18. The portable heads-up display of claim 10, wherein the information sent from the cellular telephone to the display panel includes a caller ID for an incoming call.

19. The portable heads-up display of claim 10, wherein the information sent from the cellular telephone to the display panel includes a phone number dialed on a the keypad.

20. A portable heads-up display system for a cellular telephone comprising:
transparent display means, removably affixable to a windshield of a vehicle;
data entry means for entering cellular telephone numbers to be dialed; and
connecting means, for coupling the cellular telephone and the display, affixed via temporary means to a part of the vehicle within reach of a hand of a driver of the vehicle;
wherein the connecting means sends information from the cellular telephone and the data entry means to the transparent display means.
